(19) United States
(12) Patent Application Publication
(10) Pub. No.: US 2018/0283006 A1
(43) Pub. Date: Oct. 4, 2018

(54) DOOR ELEMENT OR WALL ELEMENT

(71) Applicants: NOVATECH EUROPE, ROANNE (FR); DECEUNINCK NV, HOOGLEDE-GITS (BE)

(72) Inventors: Antoine SAINT-PIERRE, Saint-Vincent du Boissel (FR); Erik DE MAEYER, Hooglede-Gits (BE); Peter DEGRANDE, Hooglede-Gits (BE); Wim HANSSENS, Hooglede-Gits (BE)

(21) Appl. No.: 15/566,964

(22) PCT Filed: Apr. 14, 2016
(86) PCT No.: PCT/EP2016/058288

§ 371 Date: Oct. 16, 2017

(30) Foreign Application Priority Data
Apr. 14, 2015 (EP) 15163593.5

(51) Int. Cl. E04C 2/34; E06B 3/964; E06B 3/72; E04C 2/38; E04C 2/26

(52) U.S. Cl. CPC E04C 2/34; E06B 3/964; E04C 2002/3488; E04C 2/388; E04C 2/26; E06B 3/726

(57) ABSTRACT

A door or wall element includes a frame having four elongated profiles. Two side panels are provided at opposed sides of the frame and are attached to the frame. At least two of the profiles positioned at opposed sides of the frame are provided with a groove situated at the sides of the concerned profiles defining the outer circumferential surface of the frame. Each of the side panels are provided at opposed edges with an upstanding rim fitting into the concerned groove of the frame. The profiles are hollow profiles. The door or wall element includes at least one connection piece provided between two adjacent profiles of the frame, and the connection piece includes a guide surface allowing angular movements between the adjacent profiles during an assembly phase of the door or wall element.

### TECHNICAL FIELD

The present invention concerns a door or wall element comprising a frame sandwiched between two, preferably metallic, sheets or panels and whereby the inner cavity created between, on the one hand the frame and, on the other hand, both panels is filled with an insulating material.

### BACKGROUND FOR THE INVENTION

Up to present, the frame is generally made of several profiles, the profiles of such door often being manufactured in wood.

In order to increase lifetime of the door, lower production costs and increase moisture resistance, there is a market demand for replacing the wooden frame by a polymeric frame.

Such a construction is shown for example in patent document DE 201 09 011 U1, in which a door is constituted of a metal box cooperating with a metal cover, both metallic elements being connected to each other through circumferential bridge elements made of hollow multichamber profiles, the center of the assembly being filled with insulating material.

Both metallic panels are provided at two opposed longitudinal sides with a J-shaped rim comprising a lip that grips in a groove at the outer perimeter of the frame, thereby positioning the panels to the frame.

The profiles disclosed in patent document DE 201 09 011 U1 are made of ceramics or plastic material. The chambers of the multichamber profiles are closed.

However, it can be desirable to manufacture doors with hollow profiles that are open at least on part of one of their longitudinal sides.

In such case, due to the fact that polymeric profiles, in order to be light weight and structurally rigid, are hollow profiles, a one on one exchange of wooden profiles or of closed multichamber polymeric profiles by open or partially open polymeric profiles raises several issues, in particular since the process will leave the inner space of the profiles visible in the finished door and/or the inner space in the profiles will remain open to the inner cavity of the door, such that filling the inner cavity of the door with an insulating material, for example liquid polyurethane (PU), will cause leakage of the insulating material to the outside through the inner space of the profiles.

Another issue raised by known doors of this type, is that the manufacturing process consists in assembling four profiles to obtain a quadrangular peripheral frame to which the metallic panels are assembled. In order to secure the attachment of the profiles to each other, corner joints must be provided in the form of L-shaped brackets, each of both branches of the L-shaped brackets engaging with an end portion of an adjacent perpendicular profile.

However, the manufacturing process requires careful, often hand-made, positioning of the profiles of the frame perpendicular to each other prior to attaching the profiles to each other via the corner joints, and then, also hand-made, sliding in the metallic panels over the frame so that the lips of the metallic panels will engage the grooves at the outer periphery of the frame to complete the assembly.

Such manufacturing process can hardly be automatised at least in part, and raises a series of issues relating inter alia to cost of manufacturing, risks of leakage of insulating material, and other issues.

The present invention provides a solution to the above-identified problems and aims at providing a door or wall panel of the type comprising a frame sandwiched between two preferably metallic sheets or panels.

### SUMMARY OF THE INVENTION

The present invention concerns a door or wall element comprising:
A frame comprising four elongated profiles;
Two side panels provided at opposed sides of the frame and attached to said frame;
At least two of the profiles positioned at opposed sides of the frame, provided with a groove situated at the sides of the concerned profiles defining the outer circumferential surface of the frame;
   Each of the side panels being provided at opposed edges with a upstanding rim fitting into the concerned groove of the frame; wherein:
said profiles are hollow profiles,
the door or wall element comprises at least one connection piece provided between two adjacent profiles of the frame,
the connection piece comprises a guide surface allowing angular movements between said adjacent profiles during an assembly phase of the door or wall element.

By connecting the two adjacent hollow profiles together, this connection piece allows closing off at least partially these profils inner spaces. Thus, this connection piece limits on one hand the leaking of insulating material, from the inner cavity to the outside of the door element, while reinforcing on the other hand the watertightness of the door element.

In addition, manufacturing separately the frame profiles and the connection piece considerably eases the general production process of the frame by allowing the implementation of dedicated manufacturing processes and the selection of different raw materials.

Such a door element also allows implementing an assembling method in which two adjacent profiles are not initially positioned perpendicular to each other. In the meantime, the door element according to the invention remains adapted to the implementation of the assembling methods of the art, in which adjacent profiles are connected to each other along strictly perpendicular directions.

In one embodiment, the guide surface is adapted to form an abutment surface positioned against an end portion of one of the adjacent profiles inner circumferential frame surface during the assembly phase of the door or wall element, the adjacent profiles then forming an acute angle.

In one embodiment, the connection piece is an L-shaped connection piece comprising two sidewalls:
a first side wall defining a first abutment surface positioned against a cross-sectional end extending from a surface of a first profile inner circumference of the circumference of the frame;
a second side wall defining a second abutment surface extending from said first wall to the outer circumference of the frame and positioned against a cross-sectional end surface of a second frame profile;
   the guide surface being defined by a surface of the first side wall opposed to the first abutment surface and extending from the inner circumference of the frame to the second abutment surface.

In one embodiment, the guide surface extends along a plane defining an angle α with the plane wherein the first abutment surface extends and defining an angle β with the plane wherein the second abutment surface extends, whereby 0°<α<90° and 90°<β<180°.

In one preferential embodiment, the angle α ranges from 0° to 45° and the angle β ranges from 90° to 135°. The selection of these angular ranges improves the adhesion between the two adjacent profiles during the assembly phase of the door or wall element.

In one embodiment, the first abutment surface extends in a plane oriented perpendicular to the plane wherein the second abutment surface extends.

In one embodiment, the first abutment surface matches the cross-sectional end surface of the first frame profile and/or the second abutment surface matches the cross-sectional end surface of the second frame profile.

In one embodiment, the surface of the second wall opposed to the second abutment surface is profiled in accordance with the outer circumferential frame surface defined by the first frame profile.

In the following description, the expression “to profile a surface” refers to the processing or machining of this surface that aims giving to this surface a specific form or geometry. Accordingly, the profiling of the surface of the second wall opposed to the second abutment surface in accordance with the outer circumferential frame surface defined by the first frame profile allows extending to the outer circumference of the connection piece the groove of the first profile, and therefore the fitting with the upstanding rim of the concerned panel. Thus, following the assembling of the door element, this concerned panel helps to prevent the connection piece from moving by covering it at least partially. In this matter, the exact alignment of the two surfaces is considered as an advantageous feature of the frame, while the door element can bear a certain tolerance of misalignement.

In one embodiment, the connection piece comprises attachment means adapted to fix the connection piece to one of the profiles.

In the following description, the terms “attachment means” refer to any kind of engagement means, fastener or fitting adapted to engage and/or fix two pieces to each other so as to position and immobilize same in two or three directions. In a particular embodiment, the attachment means provide a permanent fixing (i.e. in three dimensions), e.g. under the form of a glue or a set of screws. However, the construction of the door according to the invention also allows for providing attachment means which are sufficient to maintain the frame together during the assembling process without permanent fixing. After assembly, the frame is immobilized by effect of the engagement of the panels inside the grooves of the profiles, such engagement locking up the connection pieces along at least one degree of freedom, function of the final steps of the assembly. Consequently, the attachment means of the connection pieces to the profiles can provide a relative positioning and immobilization of the connected elements in only two directions and/or a removable engagement, e.g. under the form of connection shafts provided on an abutment surface of the connection piece and/or fitting by plastic deformation into the inner cavity of an adjacent profile.

In one embodiment, the attachment means are provided on the first abutment surface and extend in the inner cavity of the first frame profile.

In one embodiment, the other edges of the side panels comprise an upstanding rim bent over the outer circumferential surface of the frame.

Such upstanding rim preferentially shows an L-shaped form. According to this embodiment, the frame is immobilized by the combined effect of the engagement of the panels inside the grooves of some of the profiles and over the outer circumferential surface of the others, such engagement locking up the connection pieces to the profiles, and the whole frame in a quadrangular configuration. When in addition, the surface of the second wall opposed to the first abutment surface is profiled in accordance with the outer circumferential frame surface defined by the second frame profile, such engagement can be provided on the whole outer circumferential surface of the frame. Alternatively, the L-shaped rim may only cover part of the corresponding profile or of the connection piece, while still contributing to prevent the same from moving.

In one embodiment, the panels are manufactured in a metallic material.

In one embodiment, the profiles are manufactured in a polymeric material.

The invention also pertains to a method for assembling a door or wall element comprising:
placing on a planar surface a first panel provided at opposed edges with an upstanding rim,
placing four hollow profiles on the first panel in the shape of a parallelogram, at least two of the profiles being positioned at opposed sides of the frame and provided with a groove situated at the sides of the concerned profiles defining the outer circumferential surface of the frame, so that one upstanding rim of the first panel fits into the concerned groove of one of the concerned profiles,
   at least one connection piece being provided between two adjacent profiles of the frame and comprising a guide surface upon which an end portion of one of the adjacent profiles inner circumferential frame surface is in abutment, the adjacent profiles then forming an acute angle,
placing a second panel on top of the profiles so that one upstanding rim of the second panel fits into the one of the concerned groove,
forcing the frame in a rectangular shape by an angular movement between the adjacent profiles, so that the opposed upstanding rims of the panels fit into the opposed concerned grooves of the concerned profiles.

In one embodiment, an upstanding rim of another edge of the panels is subsequently bent over the outer circumferential surface of the frame.

One main advantage of such a method is that it allows setting up an extrinsec fixation of the door element components through the cooperation of the frame profiles, the connection pieces and the side panels, and without the help of any additional fitting between the connection piece and the adjacent profiles.

In one embodiment, a hole is subsequently made in one of the profiles and an isolating material is injected into an internal cavity formed between the four profiles and the two panels.

### BRIEF DESCRIPTION OF THE FIGURES

FIG. 1 shows a frame with solid profiles (in this case wood profiles) positioned in a parallelogram set-up ready for assembly; as shown, the connection pieces are already in the solid profiles due to the fullness of the profiles for which material can be removed (versus hollow profiles).

FIG. 2 shows a door element according to the present description with hollow profiles;

FIGS. 3a&b illustrate a connection of a profile with side panels of a door element according to the present description;

FIGS. 4a&b represents a perspective view of a connection piece and profile of a door according to the present description;

FIG. 5 shows a frame of a door according to the present description in a parallelogram set-up ready for assembly with hollow profiles and connection pieces added to the hollow profiles;

FIGS. 6a&b represent a detailed view of a preferred embodiment of a connection piece for hollow profiles as described in FIG. 4.

### DETAILED DESCRIPTION OF A PREFERRED EMBODIMENT

FIG. 2 schematically represents a door element 1 according to the present invention, the door element comprising:
a frame 2 comprising four 2a&b elongated profiles;
two side panels 3a&b provided at opposed sides of the frame 2 and attached to said frame.

The invention can be implemented with many types of hollow profiles, including elongated profiles presenting either one or more closed hollow chambers or inner cavities, or having at least one such cavity being open to the outside on at least part of at least one of the longitundinal face of the profiles.

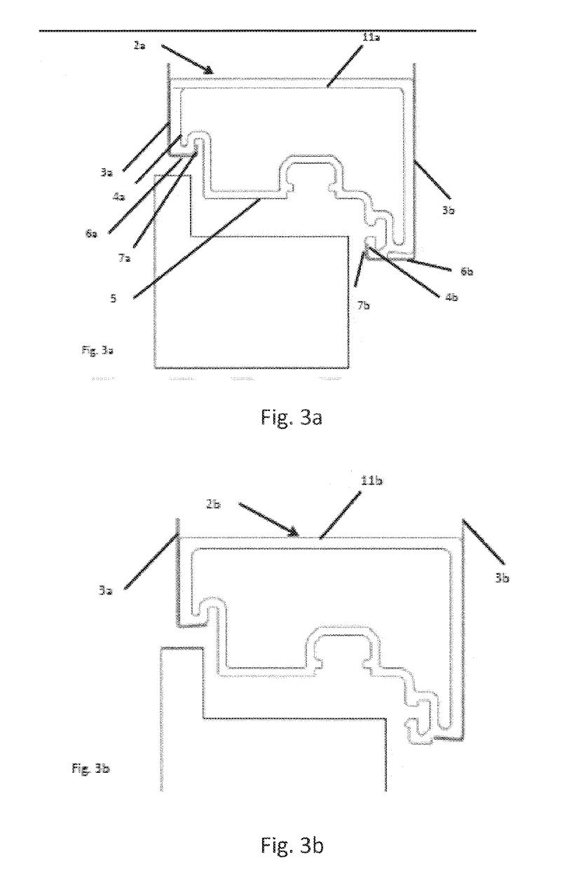

As illustrated in more detail in FIG. 3a, at least two of the profiles positioned at opposed sides of the frame, in this case the vertically positioned profiles 2a, are provided with a slot or groove 4a&b situated at the sides 5 of the concerned profiles defining the outer circumferential surface of the frame. The side panels 3a&b are provided at opposed edges with an upstanding rim 6a&b that at its free end comprises a bead 7a&b extending substantially perpendicular to the concerned side panel and fitting into the concerned groove 4a&b of the frame.

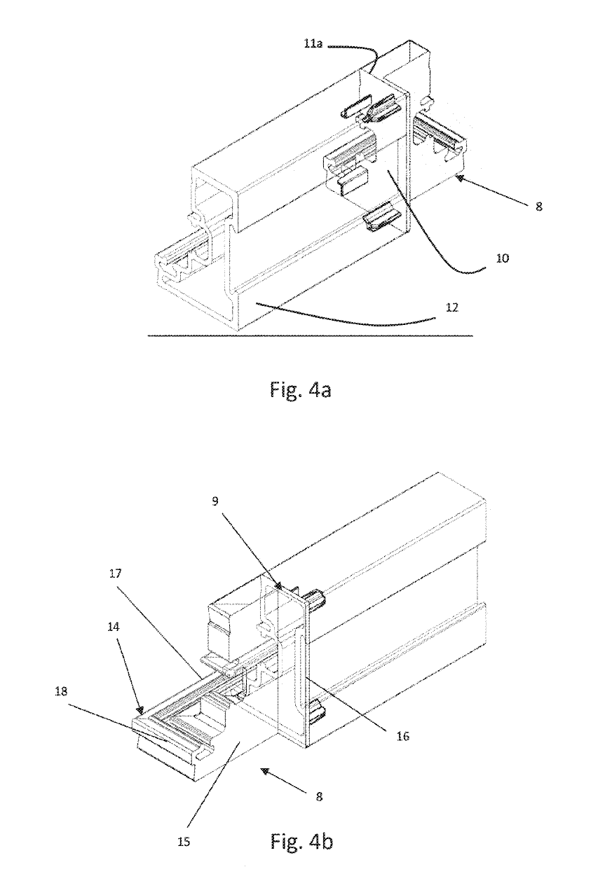

FIGS. 4a&b show a detail of a frame of a first embodiment of a door element according to the present description, wherein the frame 2 comprises a connection piece 8 provided between two adjacent frame profiles 2a and 2b. This connection piece is preferably manufactured in a polymeric material and comprising two sidewalls:
a first side wall 9 defining a first abutment surface 10 positioned against a cross-sectional end surface 11a of a first (vertically positioned) profile 2a of said frame and extending from an inner circumference 12 of the frame to an outer circumference 13 of the frame;
a second side wall 14 defining a second abutment surface 15 extending from said first wall 9 to the outer circumference 13 of the frame and positioned against a cross-sectional end surface 11b of a second (horizontally positioned) frame profile 2b.

The connection piece further defines a guide surface 16 defined by a surface of the first sidewall 9 opposed to the first abutment surface 10 and extending from the inner circumference 12 of the frame to the second abutment surface 15.

In this case the first abutment surface 10 extends in a plane-oriented perpendicular to the plane wherein the second abutment surface 15 extends. The first abutment surface 10 matches the cross-sectional end 11a surface of the first frame profile 2a, (and in the case of a hollow profile, thereby closing off the inner cavity of the hollow profile 2a at the concerned end), while the second abutment surface 15 matches the cross-sectional end surface 11b of the second frame profile 2b (and in the case of a hollow profile to close off the inner cavity of the hollow profile 2b at the concerned end).

The guide surface is preferably positioned against the inner circumferential surface of the frame defined by the second frame profile 2b such that an inner space of the door element defined between, on the one hand, the frame profiles 2a&b and, on the other hand, both side panels 3a&b, is physically separated from the inner cavity defined by the hollow profile 2b (in the case of hollow profiles), even in case of an eventual tolerance on the profile length making that the cross-sectional end surface 11b of the profile 2b would not perfectly abut the second abutment surface 15 and as such preventing that a liquid foam, when inserted in the inner space of the door element for insulation purposes would leak into the inner cavity of the frame profile 2b.

The surface 17 of the second side wall 14 opposed to the second abutment surface 15 is preferably profiled in accordance the outer circumferential frame surface defined by the first frame profile 2a, whereas the surface 18 defined by the free of the second side wall 14 is preferably profiled in accordance with the outer circumferential frame surface defined by the first frame profile 2b. As such any fittings to be provided at the outer circumferential surface of the frame can be provided both at the profiles 2a&b and at the connection piece 8.

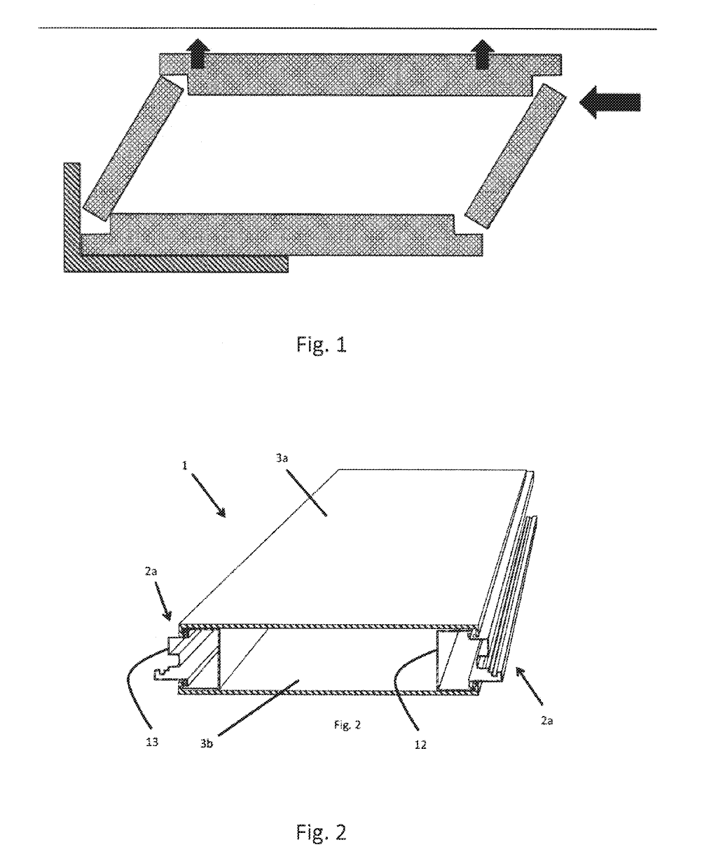

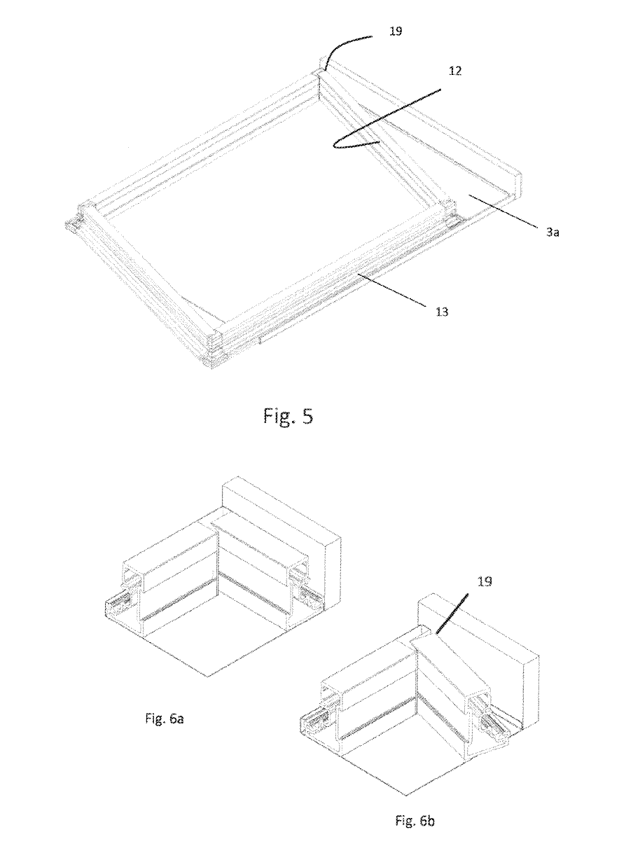

FIGS. 1 and 5 schematically illustrate the assembly method of a door element according to the present invention.

As schematically represented in FIG. 1, the door according to the invention shall be manufactured by first shaping the panels by providing these with the J-shaped rim, placing one panel on a registered table, placing the profiles for assembling the frame on the first panel in the shape of a parallelogram and placing the second panel on top of the profiles. By subsequently pushing on one of the lateral frame profiles to force the frame in a rectangular shape, the longitudinal profiles are driven apart and the J-shaped rims of the panels are forced into the corresponding grooves of the longitudinal frame profiles to assemble the door. Subsequently an upstanding rim of the remaining edges of the panels are bent over the outer circumferential surface of the transversal profiles, to form a L-shaped rim. In one embodiment, the L-shaped or J-shaped rim covers the whole length of the corresponding profile. Alternatively, the L-shaped or J-shaped rim may only cover part of the corresponding profile, without departing from the scope of the invention.

Finally, a hole is made in one of the profiles and a liquid PU-foam is inserted in the internal cavity to fill that cavity with an insulating material.

As shown in more details on FIG. 5, the profiles 2a and 2b are positioned in a parallelogram on an assembly table. In this case the frame profiles 2a intended to constitute the vertically oriented posts of the door element are provided at their both ends with a connection piece, while the frame profiles 2b intended to constitute the vertical posts of the door element are positioned such that their end portions are positioned on the guide surfaces 16 of the corresponding connection pieces 8. One of the frame profiles 2a is positioned along and against a first longitudinally extending L-shaped register wall while one of the connection pieces of that profile abuts, with its free end surface 18 of the second side wall 14, against the transversally extending part of the register wall such as to block that profile 2a from moving.

One side panel 3a is provided under the frame profiles, with one of its beads 7a,b arranged in the corresponding groove 4a, b of the immobilised profile 2a and the other side panel 3b is provided on top of the frame profiles with one of its beads 7a,b arranged in the corresponding groove 4a, b of the immobilised profile 2a.

Subsequently, the profile 2a positioned opposite the immobilized frame profile is pushed towards the transversally extending register wall part, thereby forcing the parallelogram in a rectangular shape and hence increasing the distance between the immobilized profile and its opposite counter profile of the frame and forcing the beads 7a, 7b of the side panels in the concerned grooves 4a, 4b of the opposite counter profile 2a.

During this process, the construction and shape of the connection piece, and in particular the guide surface, allow each pair of adjacent profiles to follow an angular movement with respect to each other so as to enable the frame to pass from the initial parallelogram shape to the final rectangular shape. Several shaping of the guide surface can be designed without departing from the scope of the invention.

As during the above described assembly of the door element, the transversal frame profile facing the transversally extending register wall part pivots versus the longitudinally extending profiles, the outwardly facing corner 19 of that profile 2b will push the immobilized longitudinal profile away from the transversally extending register wall part and hence disrupt a correct assembly of the door element. In order to prevent moving of the immobilized profile during assembly it is therefore preferred that the transversally extending register wall part comprises a cut-out portion allowing pivoting of the outwardly facing corner 19 without abutting the register wall part.

Alternatively, the corner piece can be provided with a sloped guide surface 16 as shown in FIG. 6a&b, preventing the outwardly facing corner from abutting the register wall during the assembly of the frame.

In this case, the guide surface 16 extends along a plane defining an angle α with the plane wherein the first abutment surface extends and defining an angle β with the plane wherein the second abutment surface extends, whereby 0°<α<90° C. and 90°<β<180°.

After the above described assembly steps, the opposed transversally extending edges of the side panels are bent over to abut the outer surfaces of the transversal profiles 2b (FIG. 3b), where after a liquid foam is injected and cured in the space defined in the door element to increase insulation properties.

1. A door or wall element comprising:
a frame comprising four elongated profiles;
two side panels provided at opposed sides of the frame and attached to said frame;
at least two of the profiles positioned at opposed sides of the frame, provided with a groove situated at the sides of the concerned profiles defining the outer circumferential surface of the frame; and
each of the side panels being provided at opposed edges with an upstanding rim fitting into the concerned groove of the frame; wherein:
said profiles are hollow profiles,
the door or wall element comprises at least one connection piece provided between two adjacent profiles of the frame, and
the connection piece comprises a guide surface allowing angular movements between said adjacent profiles during an assembly phase of the door or wall element.

2. The door or wall element according to claim 1, wherein the guide surface is adapted to form an abutment surface positioned against an end portion of one of the adjacent profiles inner circumferential frame surface during the assembly phase of the door or wall element, the adjacent profiles then forming an acute angle.

3. The door or wall element according to claim 1, wherein the connection piece is an L-shaped connection piece comprising two sidewalls, comprising:
a first side wall defining a first abutment surface positioned against a cross-sectional end extending from a surface of a first profile inner circumference of the circumference of the frame; and
a second side wall defining a second abutment surface extending from said first wall to the outer circumference of the frame and positioned against a cross-sectional end surface of a second frame profile;
the guide surface being defined by a surface of the first side wall opposed to the first abutment surface and extending from the inner circumference of the frame to the second abutment surface.

4. The door or wall element according to claim 3, wherein the guide surface extends along a plane defining an angle α with the plane wherein the first abutment surface extends and defining an angle β with the plane wherein the second abutment surface extends, whereby 0°<α<90° and 90°<β<180°.

5. The door or wall element according to claim 3, wherein the first abutment surface extends in a plane oriented perpendicular to the plane wherein the second abutment surface extends.

6. The door or wall element according to claim 3, wherein the first abutment surface matches the cross-sectional end surface of the first frame profile and/or the second abutment surface matches the cross-sectional end surface of the second frame profile.

7. The door or wall element according to claim 3, wherein the surface of the second wall opposed to the second abutment surface is profiled in accordance with the outer circumferential frame surface defined by the first frame profile.

8. The door or wall element according to claim 1, wherein the connection piece comprises an attachment adapted to fix the connection piece to one of the profiles.

9. The door or wall element according to claim 3, wherein the attachment is provided on the first abutment surface and extends in an inner cavity of the first frame profile.

10. The door or wall element according to claim 1, wherein the other edges of the side panels comprise an upstanding rim bent over the outer circumferential surface of the frame.

11. The door or wall element according to claim 1, wherein the panels are manufactured in a metallic material.

12. The door or wall element according to claim 1, wherein the profiles are manufactured in a polymeric material.

13. A method for assembling a door or wall element comprising:
placing on a planar surface a first panel provided at opposed edges with an upstanding rim,
placing four hollow profiles on the first panel in the shape of a parallelogram, at least two of the profiles being positioned at opposed sides of the frame and provided with a groove situated at the sides of the concerned profiles defining the outer circumferential surface of the frame, so that one upstanding rim of the first panel fits into the concerned groove of one of the concerned profiles,
at least one connection piece being provided between two adjacent profiles of the frame and comprising a guide surface upon which an end portion of one of the adjacent profiles inner circumferential frame surface is in abutment, the adjacent profiles then forming an acute angle,
placing a second panel on top of the profiles so that one upstanding rim of the second panel fits into the one of the concerned groove,
forcing the frame in a rectangular shape by an angular movement between the adjacent profiles, so that the opposed upstanding rims of the panels fit into the opposed concerned grooves of the concerned profiles.

14. The method for assembling a door or wall element according to claim 13, wherein an upstanding rim of another edge of the panels is subsequently bent over the outer circumferential surface of the frame.

15. The method for assembling a door or wall element according to claim 13, wherein a hole is subsequently made in one of the profiles and an isolating material is injected into an internal cavity formed between the four profiles and the two panels.

16. The door or wall element according to claim 8, wherein the attachment is provided on the first abutment surface and extends in an inner cavity of the first frame profile.
